(19) United States
(12) Patent Application Publication
(10) Pub. No.: US 2009/0028232 A1
(43) Pub. Date: Jan. 29, 2009

(54) Errors Visibility Enhancement Methods For Video Testing

(75) Inventors: Hans Andreas Baumgartner, San Diego, CA (US); Charles Benjamin Dieterich, Kingston, NJ (US)

Correspondence Address: PATENT DOCKET ADMINISTRATOR;LOWENSTEIN SANDLER P.C., 65 LIVINGSTON AVENUE, ROSELAND, NJ, 07068, US

(73) Assignee: Sarnoff Corporation, Princeton, NJ (US)

(21) Appl. No.: 12/091,875

(22) PCT Filed: Oct. 30, 2006
(86) PCT No.: PCT/US2006/042269

§ 371 Date: Oct. 8, 2008

Related U.S. Application Data
(60) Provisional application No. 60/731,360, filed on Oct. 28, 2005.

(51) Int. Cl. H04B 17/00

(52) U.S. Cl. 375/228; 375/240.27

(57) ABSTRACT

A system and method of evaluating a decoder under test can include the steps of storing a first segment of a video sequence for creating a first test frame portion including a first image, storing a second segment of video sequence for creating a second test frame portion including a second image, combining the first and second test frame portions into a visualization segment, streaming the visualization segment to the decoder, displaying the resultant output stream from the decoder under test, and determining if a defect exists in the displayed decoded output stream. Determining if a defect exists can include: if the display of the displayed visualization segment shows a steady picture, then determining there is a defect in the decoded picture, and if the display of the visualization segment shows flickering or flashing detail, then determining that there is a defect in the decoded picture.

### CROSS-REFERENCE TO RELATED APPLICATIONS

This application is the National Stage application of International Application No. PCT/US2006/42269, filed on Oct. 30, 2006, which claims the benefit of U.S. Provisional Patent Application No. 60/731,360, filed Oct. 28, 2005. The contents of both of those applications are hereby incorporated by reference herein.

### FIELD OF THE INVENTION

The present invention relates to bitstream testing systems and methods and in particular relates to improvements in the visibility of small brightness or color differences in displayed decoded pictures so as to draw the attention of the tester to these small differences.

### BACKGROUND OF THE INVENTION

The increasing development of digital video/audio technology presents an ever increasing problem of reducing the high cost of compression codecs and resolving the inter-operability of equipment of different manufacturers.

Digital decoders (such as MPEG video decoders) present a difficult testing problem when compared to analog systems. An analog system has minimal or no memory and is generally linear, such that the system's behavior is instantaneous. Thus, the behavior of an analog system can be extrapolated from one signal range to another.

In contrast, digital decoders are highly non-linear and often contain memory. A digital decoder may operate normally over a certain range of a certain parameter, but may fail dramatically for certain other values. In essence, the behavior of a digital decoder cannot be extrapolated from one signal range to another.

Generally, the testing of complex digital systems such as decoders is performed by stimulating the decoder under test with a known sequence of data, and then analyzing the output data sequences or the intermediate data sequences using, e.g., a logic analyzer, to determine if the results conform to expectations. Although this is an effective testing technique, it requires extensive knowledge of the circuit implementation or observation of internal nodes of the particular decoder.

However, in many instances, the decoder is a “black-box” that accepts a bitstream (encoded video signal) as input and provides a digital or analog representation of the decoded signal as an output. Due to product differentiation in the marketplace, it may not be possible to acquire such technical information for all decoders. In fact, even if such technical information is available, it may not be cost effective to construct a different test sequence for every decoder.

Systems and methods such as those described in U.S. Pat. No. 5,731,839, provide for systems and methods wherein, when a test bitstream is decoded by a predictive decoder, a sequence of images is produced upon a video monitor. When decoded properly, the images will have a uniformly gray region located within the decoded sequence of images. However, if the decoder improperly decodes the bitstream, a noticeable distortion will appear in the decoded images.

Such testing methods typically use a portion of an image, which should be uniform 50% gray at the end of a test. This 50% gray image portion is called a “Verify”, (but may not include the word ‘Verify’ on the screen).

When using such systems, however, two problems are present in the visual confirmation that a decoded picture really is uniformly gray: first, the tester may not look at the entire verify portion of the image; and second, the tester may not notice shadings of the gray area or small deviations, especially when two pixels deviate, one positively and one negatively in brightness (or color).

Therefore, a need exists for a method for creating a test sequence or bitstream that will produce enhanced visually detectable errors in the image produced by a video decoder if the decoder does not properly decode the bitstream.

### SUMMARY OF THE INVENTION

Embodiments of the present invention satisfy this and other needs by providing a system and method for enhancing visually detectable errors in an image produced by a video decoder.

A method of evaluating a decoder under test can include the steps of storing a first segment of a video sequence for creating a first test frame portion including a first image, storing a second segment of video sequence for creating a second test frame portion including a second image, combining the first and second test frame portions into a visualization segment, streaming the visualization segment to the decoder, displaying the resultant output stream from the decoder under test, and determining if a defect exists in the displayed decoded output stream.

The visualization segment can cause the first and second frame portions to be displayed in an alternating fashion. Determining if a defect exists can include: if the display of the displayed visualization segment shows a steady picture, then determining there is a defect in the decoded picture, and if the display of the visualization segment shows flickering or flashing detail, then determining that there is a defect in the decoded picture. The visualization segment can include a flicker tail.

Alternatively, the visualization segment includes a sweep bar tail. The flicker tail can include a first portion of a display that is inter predicted from a test result, and a second portion of the display that is intra coded gray. The sweep bar tail includes a sweeping vertical bar with horizontally continuous variable intensities.

### BRIEF DESCRIPTION OF THE DRAWINGS

The invention can be understood from the detailed description of exemplary embodiments presented below, considered in conjunction with the attached drawings, of which:

FIG. 1 is a schematic diagram of a system in accordance with embodiments of the invention;

FIG. 2 is a flow diagram illustrating a method in accordance with embodiments of the invention;

FIGS. 3a-3d are a screen shots illustrating a flicker tail display method, in accordance with embodiments of the invention; and

FIG. 4a-4d are screen shots illustrating a sweep bar tail display method, in accordance with embodiments of the invention.

It is to be understood that the attached drawings are for purposes of illustrating the concepts of the invention and may not be to scale.

### DETAILED DESCRIPTION OF THE INVENTION

With the introduction of Draft ITU-T Recommendation and Final Draft International Standard of Joint Video Specification (ITU-T Rec. H.264|ISO/IEC 14496-10 AVC), commonly called “JVT” (and MPEG4), new ways to test video compression systems have been developed. Some of these testing methods are possible with MPEG-2 and MPEG video decoders as well.

Embodiments described herein can be used in conjunction with known video testing methods such as those described in U.S. Pat. Nos. 6,400,400; 5,731,839; and 5,706,002, the contents of which are hereby incorporated by reference herein. Methods of doing such tests can include observation of an output video signal, either by human viewers or by automatic means. Described is a method of designing a test stream which specifies a sequence of decoded images using syntax elements from a compression standard and making: 1) a static set of final images and 2) a static set of final images with a reference area and a test area. Users then examine the final image for defects to determine pass or fail for the test.

In this example, there are multiple ‘final images’, and the examination uses the visibility of differences in sequentially shown images to simplify the observer's examination task. Errors in decoder operation are manifested as motion or changing appearance in the output video sequence. Such a method can reduce operator fatigue and is more sensitive to small errors than previous testing methods. Such a method can also be appropriate for machine capture and comparison of output images. An enhancement device is also described that makes decoding errors even more obvious.

A benefit of such methods is the formation of a simple set of tests that exercise many syntax elements in a methodical way. Pass or fail can be determined by looking for changing features in the displayed image. An alternative scheme, allowing the eye to scan more of the video frame, is also described.

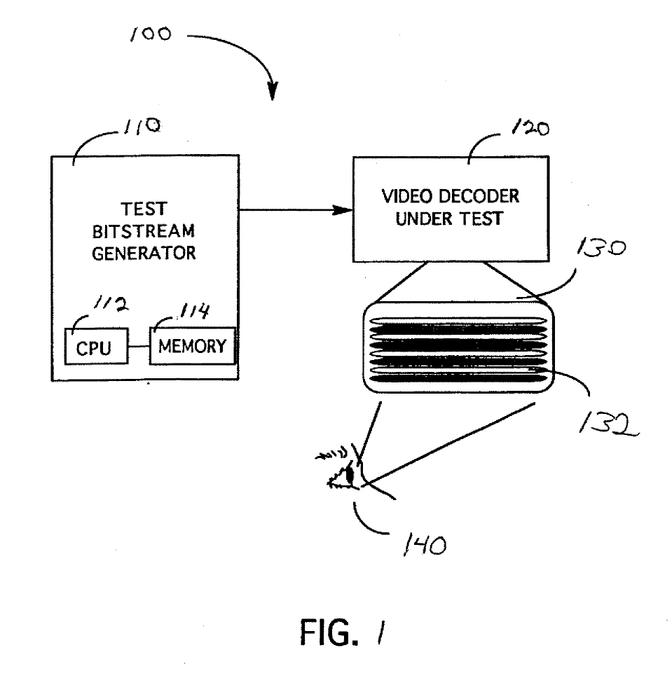

With reference to FIG. 1, bitstream testing system 100 can include a test bitstream generator 110, including a processor (CPU) 112 and a memory 114. Video segments can be stored in memory 114. Test bitstream generator 110 transmits an encoded bitstream to video decoder under test 120. In turn, video decoder under test 120 outputs a decoded bitstream to display 130 where a displayed image 132 is viewed by viewer 140. Alternatively, other system configurations can be used, as would be known to one of skill in the art, as informed by the present disclosure.

In a simple form, the testing method can comprise: 1) a segment of a video sequence which will create a first test frame with a particular image; 2) a second segment of a video sequence which will create a second test frame with an identical or nearly identical image, 3) a visualization segment of a video sequence which causes the two test frames to be displayed in an alternating fashion; and 4) the viewer applying the video sequence to a device under test, and observing the output video.

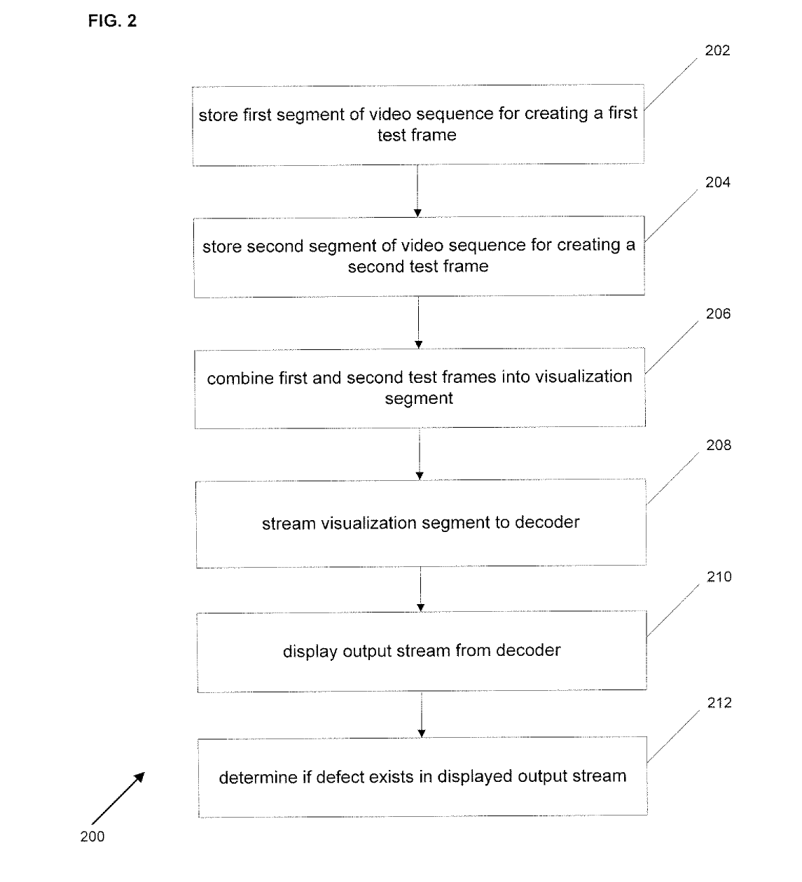

With reference to FIG. 2, the method can include storing a first segment of a video sequence for creating a first test frame including a first image (step 202); storing a second segment of video sequence for creating a second test frame including a second image (step 204); combining the first and second test frames into a visualization segment (step 206); streaming the visualization segment to the decoder (step 208); displaying the resultant output stream from the decoder under test (step 210); and determining if a defect exists in the displayed decoded output stream (step 212).

If the display of the recreated visualization segment shows a steady picture, then the images made from the first two segments have a high probability of being decoded correctly.

If the display of the recreated visualization segment shows flickering or flashing detail, then the images made from the first two segments are not ‘nearly identical’, indicating that one of the image decodings are erroneous, or there is a defect in the decoded picture buffering.

Embodiments of the invention enhance and call attention to deviations by using changes in the displayed video. In one embodiment, the tester's attention is drawn to deviations by ‘flashing’ the screen between independently-created 50% gray (not created using the syntax under test) and the test-created verify gray. While previous inventions described having a portion of the image created using “Intra coding methods”, embodiments of the present invention add additional features, specifically flashing a region of the screen between: a) intra-coded (or other reliable encoding method created) 50% ‘reference’ gray and b) the verify gray.

Visual Confirmation Test Design

Typically, H.264 bitstreams are designed to have a perfect (or near perfect) gray frame for verification. This verification frame is predicted from the previous test frames. If properly decoded, the verification frame can include perfect gray (Y=128, U=128, V=128) everywhere except the title bar. Any deviation from perfect gray in the verification frame can indicate that there are some misinterpreted syntaxes. A visual test version of a stream can include repeated title frames for a one second duration, one or more test setup frames, one or more test frames, one test verification frame, a flicker/sweep bar tail, and one test verification frame. Added features can be used to enhance error visibility. Two types of sweeping tail are flicker tail and sweep bar tail.

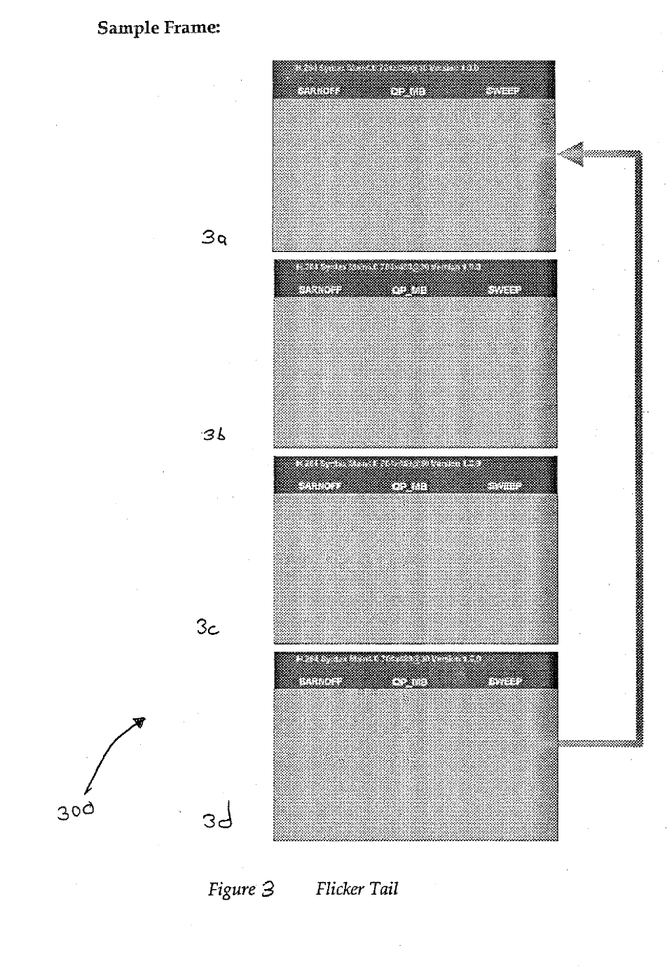

With reference to FIGS. 3a-3d, as used herein, a flicker tail includes a half screen inter predicted from the test result and a half screen intra coded gray for each frame. The two half screens are located horizontally. The tail switches the position of the inter half screen and intra half screen. As a result, any deviation from the expected output causes the tail to flicker at a fixed rate, indicating a syntax violation. If the bitstream is decoded properly, the tail shows a steady gray screen throughout the tail test sequence. Alternatively, the two half screens can be located in a non-horizontal configuration.

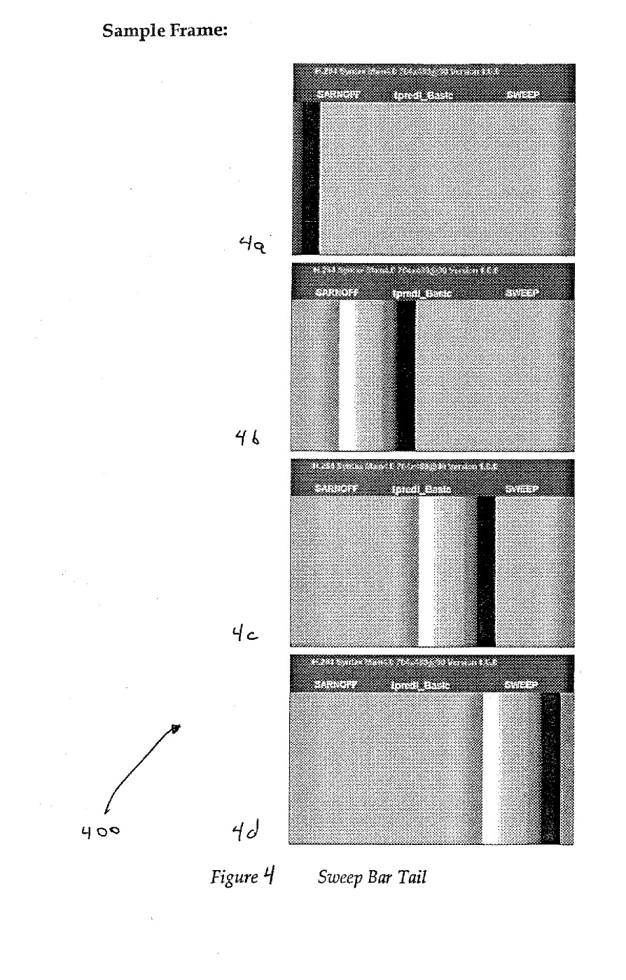

With reference to FIGS. 4a-4d, as used herein, a sweep bar tail includes a sweeping vertical bar with horizontally continuous variable intensities to provide different biases for any decoding error. The result is mapped onto the sweeping bar when its location is scanned. Anywhere other than the sweeping bar is intra coded gray. The sweeping bar moves from left to right during the entire tail test sequence. If there are any deviations from the expected output results, the error is displayed with different intensity bias on the sweeping bar. This allows errors to be more noticeable in the background as it encourages the tester to focus on the sweeping bar through the entire screen.

It has been suggested that the human eye is most sensitive to flashing at about 7.5 flashes per second. Accordingly, in one embodiment, a 30 frame-per-second video can be encoded with two frames displaying gray directly predicted from the verify gray, and then two frames displaying reference gray. In an alternate embodiment, if the correctly decoded ‘verify’ was something other than flat, fifty percent gray, the reference should be the same as it (for example, they could both be flesh toned—a color that the eye is especially sensitive to, or it can be a slowly varying brightness gradient, from top (bright) to bottom (dim), or other patterns). The test bitstream can be encoded to alternately create a region of flesh tone, 1) predicted from a flesh tone verify region and 2) created in a reference way (for example, intra-coded flesh tone pixels or predicted from an intra-coded flesh tone image portion). This flashing can last for a period of time, for example for three seconds, called the ‘sweep period’, where the tester can look at the verify portion of the image to see if errors were present.

In H.264 encoding, a decoded frame can be marked as a “long term reference frame”. Marking the ‘Verify’ frame of a syntax test (“A”) as a long term reference frame can provide a method of predicting a region in many frames directly from the verify screen (best predicted using zero motion, though other methods are possible). The reference image portion (“B”) can be intra-coded, or can be predicted from a second reference frame which was created in a reliable way (intra coding or the combination of intra and a reliable prediction coding)—the result should be the same, assuming that the reliable prediction method works properly. While flashing the entire verify area between A and B is possible, it has been found to be beneficial to flash in a sequence where the left side is predicted from “A” and the right side is created using method “B”, then the left is created using “B”, and the right is predicted from “A”. As used herein, this process is described as “left-right flashing.”

An operator can use this stream as follows. First, the stream can be played out from a memory device into a decoder. Next, the decoder can decode the H.264 signal, producing a displayable image sequence. Finally, the operator can view the image sequence, looking for flashing regions in the displayed picture during the sweep period. Errors in decoding can cause dots or areas of brightness or color, which can flicker on and off, drawing the operator's attention.

Another embodiment draws attention to errors using a moving brightness variation. In this embodiment, the verify portion can be part of an image marked as a long-term reference frame. This reference can be used in P-prediction to a gray region for many frames following it temporally (for example, the three second ‘sweep’ time).

The H.264 prediction process can also add a brightness (or color) difference to a portion of the verify gray, making the expected result in that portion be any value from 0% to 100% white.

In this embodiment, the P-prediction (as would be known to one of skill in the art, as informed by the present disclosure) adds a positive value of brightness to one portion of the verify area, and a negative value of brightness to another. Alternatively, only one polarity of brightness, or an additive color can be used. The brightness variation areas can take the form of a vertical bar, whiter on the right side, and darker on the left side. The brightness variation is the same for each line from the top of the verify region to the bottom (as if it were a vertical bar). Such a ‘bar’ moves across the screen as if it were a photocopier machine scanning a piece of paper. At the beginning of the scan period, the area should be all gray, then a white line appears at the left, then a brightness ramp appears at the left, and finally, after a dark vertical area, the left side of the screen returns to gray.

The human eye tends to follow this sort of apparent motion across the screen, and, if the bar brightness is added to deviations caused by errors in the verify reference picture, the eye will expect the variations to move with the scanning bar, but the deviations are predicted forward with zero motion, and do not move. Because the bar appears to be ‘moving’ to the human eye, the deviations appear to be moving in the opposite direction from the scanning bar. Thus, a stationary feature appears to be a moving feature, and the eye is sensitive to this apparent motion.

An operator can use an H.264 stream encoded with this ‘scanning bar’ as follows. First, the stream can be played out from a memory device into a decoder. Next, the decoder can decode H.264 producing a displayable image sequence. Finally, the operator can view the image sequence, looking for brightness changes as the scanning bar moves across the screen.

This method has the additional advantage that the operator's eyes are drawn to all areas of the screen using the motion of the bar across the screen. Also, when dot-pairs exist (bright-dark pairs that average out to gray, and are therefore hard to see), the dark dots are more visible during the whiter portion of the bar, and the bright dots will be more visible during the dark portion.

A ‘flash’ effect can also be applied, by making a columnar region following the bar be coded, not by prediction from the verify, but intra coded gray. This will cause any deviations to ‘twinkle’ as the intra-coded region moves over them.

While embodiments have been described in regard to H.264 testing, alternate embodiments can be applied to MPEG-2-like and other test streams. In testing such test streams, the long-term reference is simply an anchor frame, and the ‘sweep period’ pictures can be coded as B-pictures (as would be known to one of skill in the art, as informed by the present disclosure), using the verify picture as the basis for prediction and intra-coding the reference gray portions. Alternatively, two reference images, one intra-coded gray and the other the verify picture could also be used.

Alternatively, motion could also be down from the top of the screen to the bottom, and other bar motions, including a windshield-wiping type of motion, are possible.

In another embodiment, actual motion can be used. The entire verify region can be motion-estimated to cause it to move to the right at a rate of an integer number of pixels per field or picture. The image can be filled with reference gray from the left, and the tester can see this actual motion when performing the test. This can be done in systems without B pictures or long term reference pictures.

In addition, the tester's eyes can be drawn to an area by use of color. Instead of adding brightness, ‘yellowness’ can be added. A yellow bar can be swept across the picture. This bar can still have a luminance value of 50%, and will appear to be dark-yellow or light-brown. Brightness variations from incorrect decoding of the verify screen can appear as yellow or brown spots with apparent motion as the bar sweeps across them.

Embodiments of the methods described herein involve bitstreams that contain specific, simple variations: flicker, brightness and color variations to make errors in a verify screen more visible. In H.264 the can be implemented in a variety of ways. A typical embodiment need only have the verify screen stored as a reference picture (as would be known to one of skill in the art, as informed by the present disclosure), and the images with variations predicted from it in some parts and created in a reliable way (for example, Intra coded) in other parts.

Testing Methods for JVT-Like Decoders

As an example of a method of testing such streams, consider the following MPEG (MPEG-1 or MPEG-2) bitstream in transmission order:

The first frame, X, is an “I Picture” (as would be known to one of skill in the art, as informed by the present disclosure), with some sort of detail (not flat gray), for example, a picture of an engineer typing at a keyboard, or a slide describing the test.

The second frame, Y, is a “P Picture” (as would be known to one of skill in the art, as informed by the present disclosure), with each macroblock being coded with forward motion vectors of various sorts, but most of them non-zero motion vectors. The frame also includes DCT values of a residue to recreate the same image as displayed in the first frame.

The third through 28th frames are “B Pictures”, with even-numbered pictures consisting of only forward, zero motion, motion vectors, and odd numbered pictures consisting of only backward, zero motion, motion vectors.

This example bitstream will display a sequence of alternating images derived from X and Y. If the motion vectors used to create Y were not decoded correctly, the alternating images will not be identical, and the image will appear to flicker between the correctly decoded appearance of X and the incorrectly decoded appearance of Y.

Several variations can be used in this test:

1) Frame Y does not have to be derived from frame X. Frame X can be a P picture, derived from still earlier frames in the sequence or an I picture, and frame Y can be an I picture.

2) Both frames can be P pictures.

3) The two frames can be encoded versions of the same test image using different methods, for example with different quant scale or alternate scan methods for the DCT.

4) The third group of pictures could flash between the two images at a slower rate (e.g., XXXYYXXXYY . . . ). This need not be symmetrical between the two source images.

5) The third group of pictures could include regions coming from the X only, from Y only and from X+Y. The size and position of these regions could vary between frames within the third group.

6) Pictures in the visualization segment could include an indicator region in the image. It can be used to show which source image is being displayed or the region of the displayed image coming from each source frame. This indicator region can be intra coded. The indicator region also provides an indication that the decoder is still operating, not frozen on a single image.

7) The image area can be divided into several, for example 25, different regions in a 5×5 grid. The B pictures in the visualization segment could follow this sequence:

frame source region number

| | |
|---|---|
| FFFFFF . . . | (all F) |
| RFFFFF . . . | (first R, then all F) |
| RRFFFF . . . | (first two R, then all F) |
| RRRFFF . . . | (etc.) |

where F means that region of the picture contains macroblocks using forward motion, and R is reverse (backward) motion. In this example, the grid will convert from all forward to all backward in a slowly varying way.

8) The scanning manner can be in a boustrophedon form, as is known to those of skill in the art, or other form where region changes are always adjacent to the preceding changed region. This allows the viewer's eyes to track the changing portion of the displayed image. The sequence need not be this organized, and could even appear random.

The flicker method of error detection, as described herein, can also be applied to testing the decoder's ability to recreate B pictures, for example by decoding motion vectors correctly and decoding residual DCT coefficients. For example, half of the B frames are a reference image, created by zero motion vectors pointing to X, and the alternating B frames are predicted with non-zero motion from X, with residual DCT data which makes these frames identical to X. Note that only X is used here, but X and Y can be used as well.

The ability to see small differences can be enhanced by designing special test equipment. This equipment can take in the decoded signal, store some number of video frames (or fields) and create an output showing on a display not the image sequence, but the difference of successive video frames. This difference can be biased up into the gray brightness region and amplified such that the initial frame will appear as a bright flash, but a correctly decoded visualization segment of the sequence will appear gray (unless an error occurs, causing bright and dark flashes). The testing method is less sensitive to nonlinearities in the testing equipment because the two test images should have identical timing and identical voltages. If testing is done using composite video, the phase inversion of the chrominance might cause small differences in the difference output. The flicker rate may be set instead to a multiple of the chrominance carrier repeat rate, that is, two frames in NTSC (visualization segment sequence XXYYXXYYXXYY . . . ). If X and Y are identical, the NTSC composite waveforms will be identical two frames apart. Differences over this interval (two frames storage) can give improved detection.

Electronic detection of errors can be designed totalizing the sum of the absolute differences between the alternating frames. Because the frames will flash on errors between X and Y, timing accuracy for the capture of alternating frames does not need absolute accuracy relative to the pixel positions of the source image.

In some circumstances, the two test images X and Y may not be exactly identical. In that case the totalizing circuit could have a threshold for the sum of absolute differences or other measure.

The use of JVT greatly increases the variety of ‘testable parameters’ for this flicker testing. JVT allows prediction from different sets of pictures using short and long term entries in the Decoded Picture Buffer (DPB), as would be known to one of skill in the art, as informed by the present disclosure. Such use allows more than two test images, for example, alternating between three test images. It also allows independent chains of prediction to create the test images X and Y. Both can be P Pictures, but not derived from each other or from a common base image.

Testable parameters in JVT include entropy coding modes (CABAC vs CAVLC), slice grouping methods, deblocking filter parameters, field vs frame coding, initial quantization scale values, cabac_init_idc values, weighted prediction, values used to produce runs and levels in block encoding, motion vector types, motion vector ranges, and many other parameters. For example, X can be created with the deblocking filter off, while Y can be created with it on, but the same input image. Theoretically, X and Y should have the same pixel values. If the deblocking filter control was not implemented correctly, they will differ. The difference will appear as flicker.

In another embodiment, an additional form of flicker can be used. Instead of frame flicker (differences between frames), field flicker is also visible in interlaced displays. Coding one field as a reference FIELD X and the second field as reference FIELD Y using different parameter values allows prediction of the B picture sets alternating between the two field sources.

These streams have an interesting characteristic. The test stream consists of two parts, the anchor frame creation set of frames creates the two (or more) test frames, and the visualization segment set of frames consists of predicted frames which will produce an output with time varying combinations of the two test frames. Listed above are several types of ‘visualization segment sets’, including the frame alternating XYXYXYX, the NTSC color group alternating XXYYXXYYXXYY, the boustrophedon variation between the two test frames, and the asymmetrical XXXYYXXXYY sequence. Some of these are more appropriate for automated measurement than others, and clearly, others can be used, as would be known to one of skill in the art, as informed by the present disclosure.

To increase product flexibility, the two pieces of a video elementary stream may be manufactured independently and, based on the requirements of the tester, any one of the ‘visualization segment’ may be appended (for example, using the UNIX ‘cat’ file concatenation command) to the various anchor frame creation sets, which define which features are being tested. The concatenated video elementary stream may be used for testing.

In software testing, where internal frame buffer information is accessible, the test frames may be retrieved from memory and compared directly.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A method of evaluating a decoder under test, the method comprising the steps of:
storing a first segment of a video sequence for creating a first test frame portion including a first image;
storing a second segment of video sequence for creating a second test frame portion including a second image;
combining the first and second test frame portions into a visualization segment;
streaming the visualization segment to the decoder;
displaying the resultant output stream from the decoder under test; and
determining if a defect exists in the displayed decoded output stream.

2. The method of claim 1, wherein the visualization segment causes the first and second frame portions to be displayed in an alternating fashion.

3. The method of claim 1, wherein determining if a defect exists comprises:
if the display of the displayed visualization segment shows a steady picture, then determining there is a defect in the decoded picture; and
if the display of the visualization segment shows flickering or flashing detail, then determining that there is a defect in the decoded picture.

4. The method of claim 1, wherein the visualization segment includes a flicker tail.

5. The method of claim 1, wherein the visualization segment includes a sweep bar tail.

6. The method of claim 4, wherein the flicker tail includes a first portion of a display that is inter predicted from a test result, and a second portion of the display that is intra coded gray.

7. The method of claim 5, wherein the sweep bar tail includes a sweeping vertical bar with horizontally continuous variable intensities.

8. The method of claim 1, wherein the first frame portion includes two frames displaying gray directed predicted from the a verify gray, and the second frame portion includes two frames displaying reference gray.

9. A method of evaluating a decoder under test, the method comprising the steps of:
storing a first segment of a video sequence for creating a first test frame portion including a first image;
storing a second segment of video sequence for creating a second test frame portion including a second image;
combining the first and second test frame portions into a visualization segment;
streaming the visualization segment to the decoder;
viewing the resultant output stream from the decoder under test; and
determining if a defect exists in the displayed decoded output stream.

10. A system for evaluating a decoder under test comprising:
a processor; and
a memory coupled to the processor, the processor:
storing a first segment of a video sequence for creating a first test frame portion including a first image; and
storing a second segment of video sequence for creating a second test frame portion including a second image;
the processor configured for:
combining the first and second test frame portions into a visualization segment; and
streaming the visualization segment to the decoder;
wherein the displayed resultant output stream from the decoder under test can be viewed to determine if a defect exists in the displayed decoded output stream.

11. The system of claim 10, wherein the visualization segment causes the first and second frame portions to be displayed in an alternating fashion.

12. The system of claim 10, wherein the visualization segment includes a flicker tail.

13. The system of claim 10, wherein the visualization segment includes a sweep bar tail.

14. The system of claim 12, wherein the flicker tail includes a first portion of a display that is inter predicted from a test result, and a second portion of the display that is intra coded gray.

15. The system of claim 13, wherein the sweep bar tail includes a sweeping vertical bar with horizontally continuous variable intensities.

16. The system of claim 10, wherein the first frame portion includes two frames displaying gray directed predicted from the a verify gray, and the second frame portion includes two frames displaying reference gray.
